(19) United States
(12) Patent Application Publication
(10) Pub. No.: US 2003/0182819 A1
(43) Pub. Date: Oct. 2, 2003

(54) Process for producing durable products

(76) Inventor: Sander Germain Leon Michon, Heteren (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/275,680

(22) PCT Filed: May 11, 2001
(86) PCT No.: PCT/NL01/00360

(30) Foreign Application Priority Data
May 11, 2000 (NL) 1015161

(51) Int. Cl. F26B 13/30; F26B 7/00

(52) U.S. Cl. 34/396; 34/391; 34/92

(57) ABSTRACT

The present invention relates to a process for preserving wood, said process comprising the following steps: (1) a modification step in which wood is heated to the modification temperature and is maintained at that temperature for a specific time; (2) a cooling step in which the wood is cooled; characterized in that the wood is heated and cooled by means of heating elements which are positioned in-between the wood. Prior to the modification step, a drying step can be carried out. According to further embodiments, the process is characterized in that one or more of the steps takes place under vacuum in a sealed chamber. Preferably, a pressure is applied to the wood during the steps, with the option of varying said pressure during the process. The invention also relates to an apparatus for implementing the process.

The present invention relates to a process for preserving wood, said process comprising the following steps:

(1) a modification step in which wood is heated to the modification temperature and is maintained at that temperature for a specific time;

(2) a cooling step in which the wood is cooled.

A search has been going on for a long time for processes of preserving wood. Wood is a natural material. This has various advantages. For example, wood is the only renewable building material. This is because it grows under the influence of solar energy, water and CO₂, and this process can be repeated an infinite number of times. In addition, wood is CO₂-neutral, meaning that CO₂ is stored while the tree is growing, whereas CO₂ is re-released upon combustion or decay. With virtually all other building materials, CO₂ is released during production.

However, there is an important drawback: wood is attacked by bacteria, fungi and insects. Not all types of wood are attacked equally rapidly. If wood has good resistance against this type of attack, it is referred to as durable wood. Durable types of wood are often tropical hardwoods. These types are expensive. An alternative for this hardwood is European softwood, but only if preserved.

The currently most common and best method of preserving wood is the vacuum-pressure method. This method involves wood preservative being forced into the wood while vacuum and pressure are applied alternately. If these preservatives contain heavy metals (copper, chromium, arsenic), this is referred to as wolmanizing. If creosote oil containing polycyclic aromatic hydrocarbons (PAHs), this is referred to as creosoting. Often, the preservative can penetrate the wood only around the edges. The use of wood preservatives in the Netherlands requires a licence which is issued by the “College voor de Toelating van Bestrijdingsmiddelen” (CTB) [pesticide licensing board].

The use of a wolmanized and creosoted wood is coming under increasing pressure from environmental groups, as it is harmful to humans, animals and the environment. Indeed, expectations are that the conventional wood preservatives will be banned. Tropical hardwood is no longer an alternative for preserved wood, as it often stems from tropical rainforests. Because of the “green-lung function”, the fight against erosion and the preservation of biodiversity, it is better not to fell these forests.

For a long time, therefore, alternative preservation processes have been sought. Such a preservation process which does not have these drawbacks is the thermal treatment of wood. As a result of the wood being subjected to a temperature of 150-270° C., the physicochemical properties of the wood such as dimensional stability and durability are greatly improved. The improvements can be ascribed to the degradation of hemicellulose, molecules from a heterogeneous group of polysaccharides, and the thermocondensation of their degradation products with lignine. As the process of heating wood to improve the physicochemical properties has been known for a long time, there are a number of variations on this process.

An important process is the so-called “Shell process”, as described in EP 623,433. This involves an initial treatment of the wood with a buffered aqueous solution having a pH of 3.5-8 and being heated to about 160 to 240° C. Then the wood is dried and cured at from 100 to 220° C. U.S. Pat. No. 5,555,642 describes an almost identical process involving heating by means of “ohmic” heating, i.e. the direct application of an electrical current to the wood. U.S. Pat. No. 5,451,361 subdivides the heating step in the presence of an aqueous solution into two separate steps.

Another process used comprises three steps, viz, drying the wood, heating the wood to a “modification” temperature and cooling the wood. An example of such a process is FR 2,751,579. In particular, this involves heating of the wood in two steps: a first step up to the “softening” temperature, a second step to the rectification temperature. In FR 2,755,054 the wood is then impregnated with a monomer in order to cure it. In FR 2,751,580 the gases which are released are measured to allow the process to be controlled.

In FR 2 720 969 the heating step, in which use is made of the released gases to control the temperature, is preceded by a drying step and is followed by a cooling step consisting of water injection.

Finally, WO 94/27102 describes a process in which wood is first dried to a moisture content of 15% and is then kept in a humid environment at a temperature above 150° C. until a weight loss of at least 3% has occurred.

With most of these prior art processes, it is stated that an inert atmosphere is desirable. This prevents combustion of the wood at high temperature. Examples described for achieving such an atmosphere include operation under steam. Another option is to use an inert gas such as N₂ or CO₂.

These solutions to obtain an inert atmosphere according to the prior art are relatively expensive and moreover are often technically complex. A further drawback of the known processes is that relatively large equipment is required to ensure good heat transfer. Another problem occurring with these processes is that the wood may warp.

The present inventor has carried out extensive research into the above-mentioned technology and has ultimately reached the result described below, whereby the drawbacks of the prior art are overcome.

According to the invention, a process has now been found for preserving wood, said process comprising the following steps:

(1) a modification step in which wood is heated to the modification temperature and is maintained at that temperature for a specific time;

(2) a cooling step in which the wood is cooled; characterized in that the wood is heated and cooled by means of heating elements which are positioned in-between the wood.

Depending on the type of wood and moisture content of the wood, the modification step is preferably preceded by a drying step, in which the wood is dried. According to further embodiments, the process is characterized in that one or more of the steps takes place under vacuum in a sealed chamber. Preferably, pressure is applied to the wood during the steps, with the option of varying said pressure during the process.

This novel process has a number of advantages compared with the processes according to the prior art. These advantages are, inter alia:

The vacuum permits lower temperatures for the drying step, resulting in reduced energy consumption.

Operating at higher temperatures permits a shorter drying time.

The heat transfer by contact heat is better than that of hot air, resulting in reduced energy consumption.

No large fans are required to keep the temperature in the furnace evenly distributed, thereby saving much energy.

The resulting wood is straight, which means less loss of material during further processing.

Because pressure is applied to the wood on two sides, knots which drop out of the wood with the prior art methods will remain in the wood, thereby increasing the quality of the wood.

The furnace requires less insulation, since the vacuum around the wood is a good insulator.

The durability and the dimensional stability of the resulting wood are better.

The process can be applied both to large and to small pieces of wood, as the wood is stacked on plates rather than laths as in prior art processes.

Better drying results in better quality of the end product.

Very little or no nitrogen is required to inert the atmosphere in the installation.

As described, the process is carried out by means of heating elements which can be arranged in-between the wood. Such a heating method ensures that optimum heat transfer takes place and therefore accelerates the reduction in the wood moisture content during the drying step and the modification step. It also speeds up both heating and cooling during the other steps, resulting in a reduction in costs.

The modification step and drying step as described hereinabove can be carried out by a gradual increase in the temperature. The drying step then gradually merges into the modification step. The modification step differs from the drying step in that the wood actually undergoes a structural change during the modification step. The sole purpose of the drying step is to remove any water present as far as possible.

With certain types of wood and wood moisture contents, it is preferable for the process to be carried out step-by-step. The wood is gradually heated to the intended temperature and is then kept at that temperature for some time, as will be discussed below in more detail.

The process described in the present invention consists of a modification step, a cooling step and preferably a drying step, of which at least one is preferably carried out under vacuum. It was found to be advantageous for the modification step (1) to be split into two distinctive steps (1a) and (1b), the temperature in step (1b) being higher than in step (1a).

In addition to one or more steps under vacuum, the remaining steps preferably take place in the absence of oxygen. As described above, the presence of oxygen is known to lead to end products of inferior quality. Furthermore, the presence of oxygen may lead to spontaneous combustion of the wood, in particular during the steps (1a) and (1b) which take place at high temperatures. To keep the oxygen content as low as possible, the prior art often makes use of an inert gas such as, for example, CO₂ or N₂.

In addition, pressure is preferably applied to the wood during the process. This is because even better heat transfer takes place as a result. The abovementioned pressure is preferably a variable pressure, since a constant pressure may lead to deformation of the wood and cracking of the wood. Another advantage of using a variable pressure is that each type of wood requires a different “optimum” pressure to be selected. To meet this requirement, use is preferably made of a controllable pressure. Applying pressure also maintains the wood in the correct shape, resulting in less rapid warping.

Below, the various steps of the present process are described in more detail: the drying of the wood is carried out at 30-120° C. and preferably at 50-80° C. This step is required for a marked reduction in the moisture content of the wood. This is because the presence of moisture in the wood may lead to hydrolysis of cellulose, as a result of which the physicochemical properties of the treated wood deteriorate. As a result of the gradual increase in the temperature, the wood is not subjected to unduly rapid heating, as that may lead to cracking or splitting of the wood. An additional advantage of such a drying step is that it can be readily controlled and reproduced, thus benefiting the industrial applicability of the process.

The duration of this step and the degree to which heating takes place depends on the conditions employed, such as the level of the vacuum, type of wood, thickness of wood and moisture content of the wood. This step can therefore take from 1 to 240 hours. Those skilled in the art will be capable to optimizing these conditions, which also applies to the steps (1a), (1b) and (2) described below.

If this step is carried out under vacuum, which is preferable, the vacuum is ≦50 kPa, preferably ≦30 kPa.

According to a preferred embodiment of the invention, the wood, depending on the type of wood and the moisture content, is then subjected to a first heating step (1a). In this step, any moisture still present is removed and the temperature of the wood is homogenized before proceeding with step (1b). In this phase, tension is removed from the wood, this step (1a) is sometimes referred to as softening step. This step is carried out at 110-180° C. and preferably at 150-170° C.

The third step in the process (step 1b) consists of further heating of the wood to 200-290° C. and preferably 225-245° C. This is the preservation step. Since prolonged exposure of wood to these temperatures can lead to the formation of by-products (due to acid-catalysed degradation of cellulose), which reduce the quality of the treated wood, this heating step is as brief as possible.

The last step consists of cooling the wood to a temperature of 50-120° C., preferably 60-80° C.

The vacuum pressure during step (1a), (1b) and (2) is preferably ≦25 kPa, more preferably ≦10 kPa. At the end of the cooling step (2) the pressure can increase again.

The present invention also relates to an apparatus for implementing the process for preserving wood. The apparatus comprises a housing into which the wood is placed, heating elements which are arranged in-between the wood, and means by which a variable pressure can be applied to the wood, the apparatus being provided with control means designed for raising or lowering the temperature in a stepwise manner, the vacuum and the pressure applied to the wood.

Preferably, the control means are linked to the heating elements in such a way that the latter can be heated or cooled to the suitable temperature. Additionally, the control means are also linked to means for determining the temperature of the wood. Careful control of the heating rate and the duration of each step is thus possible.

The heating elements can be hollow, allowing a chosen heating medium, for example water, oil, steam or air, to flow through them. One option is to heat the heating elements electrically. The hollow heating elements are preferably made of aluminium.

As described, the apparatus also includes means for applying a pressure to the wood. These can be hydraulic of mechanical means. Another option is to apply a pressure to the wood either manually or by air pressure. One possible embodiment is a bag which can be filled with air and placed on the wood. The pressure and the temperature can be adjusted depending on type of wood and thickness of the wood. The invention also comprises the use of a pulsed pressure, i.e. a pressure which alternately is high for a prolonged period, resulting in good heat transfer between wood and heating element, and a pressure which is low for a short time, thus preventing the wood from cracking and splitting.

The housing is of such a design that it can be sealed in a pressure-tight manner. Means are present which ensure that the housing can be put under vacuum. In particular, a vacuum is created by means of a vacuum pump.

The following table gives an overview of a possible process according to the present invention. As described above, exact heating time and temperature increase will depend, inter alia, on the quantity and the type of wood. This example should therefore by no means be seen as limiting.

| | | | | Dwell time at | |
|---|---|---|---|---|---|
| | | Heating or | Heating or | selected | Total duration |
| | Temperature | cooling rate | cooling time | temperature | of step |
| Step | (° C.) | (° C./min) | (min) | (min) | (min) |
| Drying step | 100 | 3 | 27 | 120 | 147 |
| Softening step | 160 | 3 | 20 | 160 | 180 |
| Preserving step | 240 | 3 | 27 | 60 | 87 |
| Cooling step | 60 | 3 | 60 | — | 60 |
| Total | | | | | 474 |

1. Process for preserving wood, said process comprising the following steps:
(1) a modification step in which wood is heated to the modification temperature and is maintained at that temperature for a specific time;
(2) a cooling step in which the wood is cooled; characterized in that the wood is heated and cooled by means of heating elements which are positioned in-between the wood.

2. Process according to claim 1, characterized in that said process comprises a drying step which precedes the modification step and in which the wood is dried.

3. Process according to claim 1 or 2, characterized in that, during the modification step (1), the heating takes place in two distinctive steps (1a) and (1b), the temperature in step (1b) being higher than in step (1a).

4. Process according to any one of claims 1 to 3, characterized in that the drying step, the modification step and/or the cooling step take place under vacuum in a sealed chamber.

5. Process according to any one of claims 2 to 4, characterized in that the drying step takes place at a temperature of 30-120° C., preferably 50-80° C.

6. Process according to claim 5, characterized in that the drying step takes place under vacuum.

7. Process according to any one of claims 3 to 6, characterized in that step (1a) takes place at a temperature of 110-180° C., preferably 150-170° C.

8. Process according to claim 7, characterized in that step (1a) takes place under vacuum.

9. Process according to any one of claims 2 to 8, characterized in that step (1b) takes place at a temperature of 200-290° C. and preferably of 225-245° C.

10. Process according to claim 9, characterized in that step (1b) takes place under vacuum.

11. Process according to any one of claims 1 to 10, characterized in that, during the cooling step, the wood is cooled to a temperature of 50-120° C., preferably to 60-80° C.

12. Process according to claim 11, characterized in that the cooling step takes place under vacuum.

13. Process according to any one of claims 1-12, characterized in that pressure is applied to the wood during the treatment steps, with the option of varying said pressure during the process.

14. Apparatus for implementing the process for preserving wood according to any one of claims 1 to 13, comprising a housing into which the wood is placed, heating elements which are arranged in-between the wood, and means by which a variable pressure can be applied to the wood, the apparatus being provided with control means designed for raising or lowering the temperature in a stepwise manner.

15. Apparatus according to claim 14, characterized in that the control means are linked to the heating elements in such a way that the latter can be heated or cooled to the suitable temperature.

16. Apparatus according to claim 15, characterized in that the control means are also linked to means for determining the temperature of the wood.
